(19) United States
(12) Patent Application Publication
(10) Pub. No.: US 2020/0365298 A1
(43) Pub. Date: Nov. 19, 2020

(54) WIRE FENCE INSULATOR AND BUFFER

(71) Applicant: LENNOX RURAL PTY LTD, Leederville, Western Australia (AU)

(72) Inventor: Brett William LYALL, Darkan, WA (AU)

(21) Appl. No.: 16/762,562

(22) PCT Filed: Nov. 8, 2018
(86) PCT No.: PCT/AU2018/000218

§ 371 Date: May 8, 2020

(30) Foreign Application Priority Data
Nov. 8, 2017 (AU) 2017904526
Jun. 14, 2018 (AU) 2018902124

(51) Int. Cl. H01B 17/14; A01K 3/00; E04H 17/12

(52) U.S. Cl. CPC H01B 17/145; E04H 17/12; A01K 3/005

(57) ABSTRACT

A wire fence insulator and buffer (10, 100, 200) for retrofitting to a wire fence of the type where the fence wire (18) passes through lateral apertures (26) in fence posts (16). The wire fence insulator and buffer (10, 100, 200) has an inner member (12, 112, 212) and an outer member (14, 114, 214) capable of coupling together around the fence wire (18) within respective ones of the lateral apertures (26) of the fence post (16) to inhibit leakage of electrical energy from the fence wire (18) to the fence post (16) and/or to inhibit wear and corrosion of the fence wire (18) with the fence post (16). A wire fence system and method of electrification of the wire fence are also claimed.

### FIELD OF THE INVENTION

This invention generally relates to a wire fence insulator and buffer for retrofitting to a wire fence of the type where the fence wire passes through lateral holes in fence posts.

More particularly, the present invention relates to an electrical insulator for retrofitting to a wire fence for electrification of the fence by inhibiting leakage of electrical energy from the fence wire to the fence post.

Another embodiment of the present invention relates to a buffer for retrofitting to a wire fence to mechanically buffer the fence wire from the fence post to reduce corrosion and wear.

The electric fence insulator and buffer of the present invention is applicable to fence posts having mutually parallel vertically spaced apart lateral apertures each for receiving a strand of fence wire for creating an electrified barrier capable of inhibiting the passage of livestock or other animals.

That is, the wire fence insulator and buffer of the present invention may also be used with or without a wire fence electrification device. In the former case the insulator and buffer provides electrical insulation. In the latter case the insulator and buffer prevents contact between the fence posts and fence wires, which substantially eliminates points of wear, thus avoiding rusting and damage to the fence wires, which greatly increases the serviceable life of the wire fence.

The main difference between the electric fence insulator of the present invention and the fence wire buffer of the present invention is that the former must be capable of electrically isolating the wire from a fence post and the latter does not.

The wire fence insulator and buffer of the present invention may be used with steel pickets of the type generally having three flanges, such as, for example, those commonly referred to as star-pickets or Y-pickets or T-posts. However, the steel posts could also have other shapes, such as, for example, U-shape cross-section.

The wire fence insulator and buffer of the present invention may also be used with wooden and concrete material posts, such as, for example, those having a substantially circular or square cross-section. The electric fence insulator of the present invention may also be used with hollow posts, provided they have lateral apertures passing through them.

The wire fence insulator and buffer of the present invention may also be used for fitting an electric fence function during installation of a new fence.

The present invention does not relate to the art of fence wires that are attached to the sides of fence posts, wherein the fence wires are tied with wire or other fixings to the side of the fence posts.

### TERMINOLOGY

In the context of the present invention the following specific terminology is used:
“buffer” refers to the provision of a barrier between a fence wire and a fence post to reduce wear and corrosion between the fence wire and the fence post;
“electrified fence” refers to the application of relatively high voltage, relatively low current pulsating electricity to fence wires to deliver a not fatal electrical shock to animals attempting to breach the fence to increase the ability of the fence to serve as a boundary to contain animals;
“fence post” refers to an upright elongate member used to support laterally disposed fence wires;
“fence wire” refers to long drawn metal threads used to create a boundary or barrier;
“insulator” refers to electrical insulation between a fence wire and a fence post, both made of electrically conducting metals materials. Insulator does not refer to, nor include, thermal insulation;
“mechanically buffered” refers to mechanically separating the fence wire from the fence post;
“pulsating current electricity” refers to electrical energy pulses delivered through fence wires, with the pulses occurring about once every second for about 1/300th of a second so as to deliver non-fatal electrical shock to animals attempting to breach the fence;
“relatively high voltage” refers to pulsating electricity between 2,000 volts and 15,000 volts, and more particularly between 7,000 volts and 12,000 volts; and
“relatively low current” refers to pulsating electricity between 15 milliamps and 500 milliamps, and more particularly between 100 milliamps to 150 milliamps;
“steel pickets” refers to metal posts having three flanges, often referred to as T-posts or Y-posts or star pickets, and to metal posts having a U-shaped cross-section or even in the form of a hollow posts.

### BACKGROUND TO THE INVENTION

Electrified fences are often used to contain livestock within a field or paddock—by inhibiting the livestock from pushing or crashing through the fence. Such electrified fences are especially effective for sheep, cows and horses. Electrified fences are also used to keep wild animals out of areas of value, such as, for example, excluding bears from storage sheds.

Electrified fences typically have wooden or steel or concrete posts driven into the ground and electrically conducting metal wires attached to the posts by insulators. Typically, the electrically conducting wires are attached to the side of the posts by insulators, for example as shown in U.S. Pat. No. 4,771,137 and U.S. Pat. No. 4,965,413. Some prior art systems of fence electrification have through-hole insulators, for example AU28416/84 for use with star pickets and WO03049125 for use with hollow metal posts.

The main limitation with these prior art fence post insulators is that they are not able to be used with fence wire that is already installed. In the case of '137 and '413 the insulators are for carrying additional electrified wire and do not permit existing fence wires to be electrified. These prior art insulators require additional strands of wire to be added to the fence for electrification. In the case of '416 and '125 the insulators can only be used when installing the fence wire into the fence posts. The latter two have the added disadvantage that they must be inserted into the holes in the fence posts before the fence wire is inserted into the holes.

What is needed is an electric fence insulator that can be used to convert an existing wire fence into an electrified wire fence without the need to add further strands of wire to the fence. Or put another way, what is needed is an electric fence insulator that can be installed onto a wire fence after the wire has been installed into the fence.

### SUMMARY OF THE INVENTION

Therefore, it is an object of the present invention to provide a wire fence insulator and buffer capable of being installed onto a wire strand of a fence after the wire strand has been installed into the fence.

In accordance with one aspect of the present invention, there is provided an electric fence insulator for a fence post having spaced apart lateral apertures with fence wire passing through them, the electric fence insulator comprising:

an inner member and an outer member capable of coupling together around the fence wire within respective ones of the lateral apertures of the fence post to inhibit leakage of electrical energy from the fence wire to the fence post;

wherein the inner member and the outer member can be coupled together in respective ones of the said lateral apertures around the fence wire after the fence wire has been fitted to the fence post.

In accordance with another aspect of the present invention, there is provided a fence wire buffer for a fence post having lateral spaced apart apertures with fence wire passing through them, the fence wire buffer comprising:

an inner member with an elongate body having a wire slot shaped to receive the fence wire extending along its length, the wire slot allowing the inner member to be located upon the fence wire, so the body can pass through the said lateral aperture from one side of the fence post; and

an outer member with an elongate body having a mating slot shaped to receive the body of the inner member, the mating slot extending along the length of the elongate body, the elongate body of the outer member being dimensioned to pass through the said lateral aperture from the other side of the fence post;

whereby the inner and outer members couple together within the lateral aperture to inhibit contact of the electric wire with the fence post.

In accordance with yet another aspect of the present invention, there is provided an electric fence system comprising:

a plurality of fence posts arranged in side-by-side spaced apart relation, each fence post having at least one lateral aperture extending through it;

at least one fence wire capable of carrying electric current, the at least one fence wire being disposed through a corresponding one of the lateral apertures in the fence posts; and a plurality of electric insulators for electrically insulating the fence wires from the fence posts, each electric insulator comprising:
an inner member with an elongate body having a wire slot shaped to receive the fence wire extending along its length, the wire slot allowing the inner member to be located upon the fence wire with the body located through the said lateral aperture from one side of the fence post; and
an outer member with an elongate body having a mating slot shaped to receive the body of the inner member, the mating slot extending along the length of the elongate body, the elongate body of the outer member being dimensioned to pass through the said lateral aperture from the other side of the fence post;
whereby the inner and outer members couple together within the lateral apertures to inhibit leakage of electricity contact of the electric wire with the fence post; and

an electric charge device for delivering electric charge to the fence wire.

In accordance with yet another aspect of the present invention, there is provided a method of electrifying a wire fence having a plurality of fence posts each with lateral spaced apart apertures with respective fence wires passing through them, by using a fence post insulator comprising an inner member with an elongate body having a wire slot shaped to receive the fence wire extending along its length, the wire slot allowing the inner member to be located upon the fence wire so the body can pass through the said lateral aperture from one side of the fence post, and an outer member with an elongate body having a mating slot shaped to receive the body of the inner member extending along its length, the body of the outer member being dimensioned to pass through the said lateral aperture from the other side of the fence post, the method comprising the steps of:
locating the wire slot of the inner member onto a respective one of the fence wires;
sliding the inner member about the respective fence wire into one of the lateral apertures of the fence post;
locating the mating slot of the outer member onto the said fence wire on the opposite side of the said fence post from the inner member;
aligning the inner member and the outer member;
inserting the inner member into the outer member within the said lateral aperture for coupling the inner member and the outer member together; and
sliding the outer member into the said lateral aperture;

whereby the electric fence insulator inhibits leakage of electrical energy from the fence wire to the fence post.

Preferably, the inner and outer members, once coupled together, are not able to rotate with respect to each other.

Preferably, the inner and outer members include means to resist their separation, once they are coupled together.

Typically, means is provided for centralising the inner member and the outer member with respect to the fence post in the said lateral aperture,

The fence posts could be made of metal or non-metal materials.

The fence wires could be electrified or not electrified. In an electrified state the insulator inhibits leakage of electricity from the fence wires to the fence post and in a non-electrified state the insulator act as a buffer to inhibit wear and corrosion of the fence wires with the fence posts.

Unless the context clearly requires otherwise, throughout this description the words “comprise”, “comprising”, “including”, “containing” and the like are to be construed as open-ended or in an inclusive sense, as opposed to closed or in an exclusive or exhaustive sense; that is to say, “comprise” etc and the like are to be construed to mean the inclusion of a stated integer or step or group of integers or steps but not the exclusion of any other integer or step or group of integers or steps. Or put another way, “comprise” etc and the like are not to be considered in the sense of “including”, but more in the sense of “including, but not limited to”.

### BRIEF DESCRIPTION OF THE DRAWINGS

The nature of the invention will be better understood from the following description of specific embodiments of the present invention, given by way of example only, with reference to the accompanying drawings, in which:

FIG. 1 is a perspective view, seen from above, of an electric fence insulator in accordance with one embodiment of the present invention;

FIGS. 2 and 3 are respectively side views of an inner member and an outer member of the electric fence insulator of FIG. 1;

FIG. 4 is a perspective view, seen from above, of the inner member of the electric fence insulator of FIG. 1;

FIG. 5 is a perspective view, seen from below, of an outer member of the electric fence insulator of FIG. 1;

FIGS. 6, 7 and 8 are a front and perspective view, respectively, of the electric fence insulator of FIG. 1, shown installed into a lateral aperture of a star picket fence post;

FIG. 9 is a perspective view seen from above of another embodiment of the electric fence insulator of the present embodiment, similar to FIG. 1, but incorporating the outer member of FIG. 12 and shown from the end of the outer member;

FIG. 10 is a perspective end view of the electric fence insulator of FIG. 9, shown from the end of the inner member;

FIG. 11 is a perspective end view of the electric fence insulator of FIG. 9, shown from the end of the outer member;

FIG. 12 is a perspective view, seen from above, of an inner member of the electric fence insulator of FIG. 9, and is similar to the outer member shown in FIG. 5;

FIGS. 13 and 14 are plan and side views, respectively, of the inner member shown in FIG. 12;

FIG. 15 is a perspective view, seen from above, of an outer member of the electric fence insulator of FIG. 9, and is similar to the outer member shown in FIG. 5; and

FIGS. 16 and 17 are plan and side views, respectively, of the outer member shown in FIG. 15.

FIG. 18 is a perspective view, seen from the side, of an outer member of an electric fence insulator in accordance with yet another embodiment of the present invention;

FIG. 19 is a perspective view, seen from the side, of an inner member of an electric fence insulator in accordance with the embodiment of FIG. 18;

FIGS. 20 to 23 are respectively, plan, side, cross-section on A-A and cross-section on C-C views of the members of FIGS. 18 and 19, shown assembled.

### DETAILED DESCRIPTION OF PREFERRED EMBODIMENTS

In the drawings there is shown several embodiments of the present invention, which shall now be described in detail, by way of example of the construction and use of the invention. The embodiments are not intended to limit the disclosure or description of the invention set out above. In the drawings, incorporated to illustrate features of the exemplary embodiments, like reference numerals are used to identify like parts throughout.

Also, whilst various examples and alternatives are described herein, these are not intended to limit the overall scope of he invention in any way unless the context clearly indicates otherwise.

It is also to be noted that one example or embodiment may exemplify certain aspects of the invention, whilst other aspects are exemplified in a different example or embodiment.

### Embodiment 1

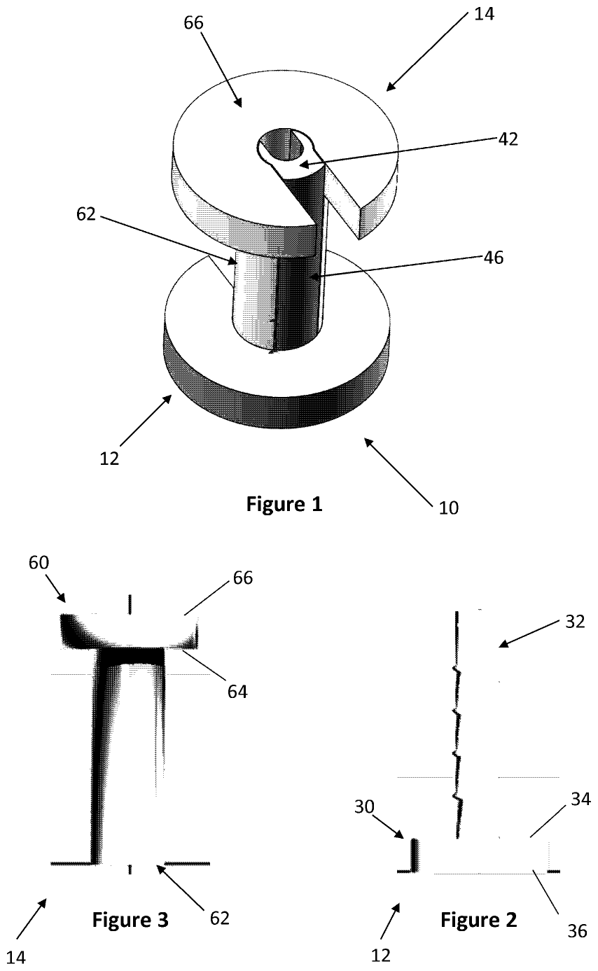

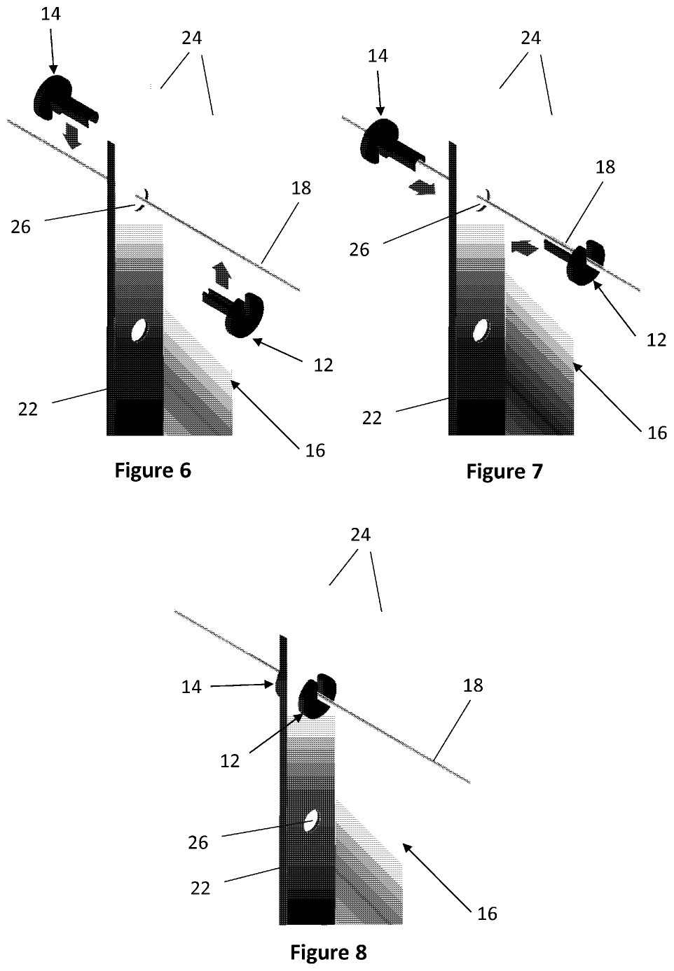

In one exemplary embodiment of the present invention there is described an insulator/buffer 10, with an inner member 12 and an outer member 14, as shown in FIGS. 1 to 5. The inner member 12 is shaped to fit part way into the outer member 14 to form a generally bobbin shaped insulator/buffer 10. The bobbin shape permits the insulator/buffer 10 to be fitted to a wire fence to permit electrification of an existing wire fence. The wire fence is made with a plurality of spaced apart fence posts 16 each supporting a plurality of generally horizontally disposed fence wires 18, as shown in FIGS. 6 to 8. Typically, the fence post 16 and the fence wire 18 are formed of metal materials. Although, the fence post 16 could be formed of wooden or plastics materials. In the present embodiment the fence post 16 is in the form of a post generally referred to as a star picket, or Y-post, although it could be a T-post or other shape of elongate post.

The star picket type fence post 16 of the present embodiment has a main flange 22 from which depend two minor flanges 24 in a Y-shaped configuration. The flanges 22 and 24 are typically at an angle of about 120 degrees to each other. The fence post 16 has an upper most head end configured for striking with a driver for driving the fence post 16 into the ground. The fence post 16 also has a tail end (not shown) which is shaped into a point for being driven into the ground. The main flange 22 has a plurality of apertures, conveniently in the form of holes 26, two of which are shown in FIGS. 6 to 8. The holes 26 may be spaced regularly or irregularly along the length of the fence post 16. The flanges 22 and 24 are typically about 2 to 6 mm thick, more particularly about 4 mm, and about 30 mm wide (measured transverse to the length of the fence post 16). The fence posts 16 are typically between about 0.5 metres and 2.5 metres long.

Typically, the fence wire 18 has a diameter of between 2.5 mm and 7 mm, more particularly, about 4 mm. Wire commonly used for horse enclosures is plastic coated and has a diameter of about 7 mm (although this is not suitable for electrification).

Typically, the holes 26 in the main flange 22 are about 10 mm in diameter. Although, in some cases the holes are elongate in the longitudinal direction of the flange 22. In some cases, the holes 26 are in the form of slots that extend to the free edge of the flange 22 so that the wire 18 can be inserted laterally onto the fence post 16. The insulator/buffer 10 of the present invention is not intended for use in relation to such open slot type fence posts.

The fence post 16 could be square or rectangular or round or irregularly shaped in cross-section, provided it has the holes 26 disposed generally laterally through it. Also, the fence post 16 could be either solid or hollow. The fence post 16 could also be U-shaped in cross-section.

Typically, the insulator/buffer 10 fits loosely in the hole 26. Although, a snug fit between the insulator/buffer 10 and the hole 26 is acceptable, provided the speed of insertion of the insulator/buffer 10 into the hole 26 is not adversely slowed.

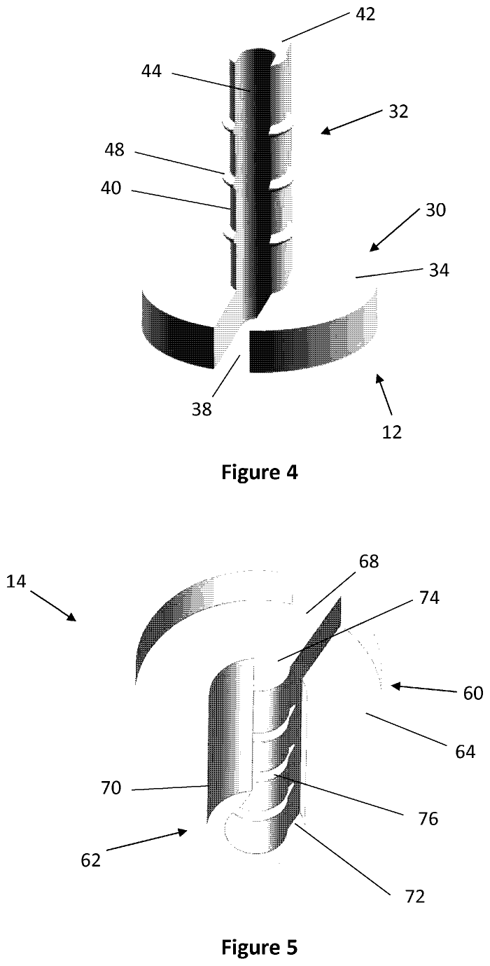

Particularly as shown in FIGS. 2 and 4, the inner member 12 has a base 30 and an elongate body 32 depending typically at about 90 degrees from the base 30. The base 30 is conveniently circular in plan and rectangular in side elevation and has opposing inner and outer faces 34 and 36 which, in the present embodiment, are generally parallel to each other. Thus, the base 30 is shaped generally like a coin.

The base 30 also has a slot 38 extending from its periphery to its central axis. The slot 38 is typically oriented radially and has substantially parallel side walls that typically are spaced apart slightly more than the diameter of fence wire 18. For example, where the fence wire 18 has a diameter of 4 mm, the slot 38 has a width of between 5 mm and 7 mm.

The shape of the base 30 could be other than circular, such as, for example, square, rectangular, hexagonal or irregularly shaped.

The elongate body 22 has is generally U-shaped portion 40 with a key 42 disposed along its length. The U-shaped portion 40 is generally cylindrical in its inner and outer shape, although the inner shape may have substantially mutually parallel sides. The U-shaped portion 40 defines a channel 44 which extends into the slot 38 in the base 30. The channel 44 is slightly wider than the diameter of the fence wire 18 and substantially the same width as the slot 38. However, the entrance to the channel 44 may be slightly smaller than the diameter of the fence wire 18, thus relying upon the resilience of the elongate body 32 to permit location of the inner member 12 onto the fence wire 18. That is, the inner member 12 can be located laterally upon the fence wire 18, whilst the fence wire 18 is in situ in the fence installation.

Typically, the channel 44 is slightly larger in cross-section, and the slot slightly larger in width, than the diameter of the fence wire 18 for convenient location of the inner member 12 onto the fence wire 18. Although, the dimensions of the channel 44 and the slot 38 could be such that there is an interference fit between the inner member 12 and the fence wire 18. Alternatively, the inner member 12 could have a loose fit on the fence wire 18 such that lateral movement of the fence wire 18 with respect to the inner member 12 is possible.

In the context of the present invention the channel 44 and the slot 38 are collectively referred to as a “wire slot” of the inner member 12. The wire slot of the inner member 12 is essential to the capacity of the insulator/buffer 10 to be retrofitted to an existing fence installation. Without the wire slot the inner member 12 would have to be inserted from a free end of the fence wire 18 and this would prevent retrofitting of the insulator/buffer 10 to an existing wire fence installation.

The key 42 is disposed along the length of the acuate segment of the U-shaped portion 40. As can be better seen in FIGS. 1 and 4, the key 42 is generally rectangular in cross-section and has a back 46, see FIG. 1, which is typically curved, such as, for example, as a segment of a circle.

In the present embodiment the key 42 is shown as solid, however, it could be hollow along some or all of its length.

The U-shaped portion 40 typically has one or more ribs 48 disposed along its length for convenient engagement of the inner member 12 with the outer member 14. The or each rib 48 is typically disposed generally circumferentially on the outer curved surface of the U-shaped portion 40. The ribs 48 may be semicircular or generally triangular in cross-section and terminate at one end at the channel 44 and at their other end at the key 42.

In this embodiment there are three ribs 48 uniformly spaced apart along the length of the body 32. Although, there could be other numbers of ribs 48, such as, for example, two or one rib 48.

Typically, the inner member 12 is about 22.5 mm long, the base 30 about 20 mm in diameter, the body 32 about 20 mm long, the wire slot about 4 mm wide and the key about 5 mm wide.

Particularly as shown in FIGS. 3 and 5, the outer member 14 has a base 60 and an elongate body 62 depending typically at about 90 degrees from the base 60. The base 60 is conveniently circular in plan and rectangular in side elevation and has opposing inner and outer faces 64 and 66 which, in the present embodiment, are generally parallel to each other. Thus, the base 60 is shaped generally like a coin.

The base 60 also has a slot 68 extending from its periphery to its central axis. The slot 68 is typically oriented radially and has substantially parallel side walls that typically are spaced apart substantially the same distance as the width of the key 42. The slot 68 is wide enough to receive the key 42 of the inner member 12, thereby inhibiting rotation of the inner member 12 with respect to the outer member 14.

The shape of the base 60 could be other than circular, such as, for example, square, rectangular, hexagonal or irregularly shaped.

The elongate body 62 has is generally C-shaped portion 70 with a keyway 72 disposed along its length. The C-shaped portion 70 is substantially cylindrical in its inner and outer shape. The C-shaped portion 70 defines a channel 74 which extends into the slot 68 in the base 60. The inner diameter of the channel 74 is substantially the same as the outer diameter of the body 32 of the inner member 12. That is, the outer member 14 can be slid onto the body 30 of the inner member 12, whilst the inner member 12 is located upon the fence wire 18.

Typically, the channel 74 is slightly larger in cross-section, and the slot slightly larger in width, than the diameter of the body 32 and the key 42 of the inner member 12 for convenient location of the outer member 14 upon the inner member 12. Although, the dimensions of the channel 74 and the slot 68 could be such that there is an interference fit between the body 32 of the inner member 12 and the channel 74 and the keyway 72 of the outer member 14.

The body 62 of the outer member 14 also has circumferentially disposed grooves 76 terminating at the keyway 72. The grooves 76 have a cross-sectional shape which is complementary to the cross-sectional shape of the ribs 48 of the inner member 12. The grooves 76 are arranged to engage with and retain the ribs 48 of the inner member 12, for inhibiting longitudinal movement of the two members 12 and 14 with respect to each other once assembled (see FIG. 1). Typically, there are at least as many grooves 76 as there are ribs 48 on the body 32 of the inner member 12, and the grooves 76 are positioned so one rib 48 mates with one groove 76.

Alternatively, the ribs 48 and the grooves 76 could be omitted, provided the channel 74 and the keyway 72 are dimensioned for an interference fit with the inner member 12, so that the members 12 and 14 couple together and are inhibited from separating from each other when in use installed into the fence.

Alternatively, the ribs 48 and grooves 76 could be omitted and the end 42 of the inner member 12 configured to have an interference fit with the channel 74 of the outer member 14 so that the members 12 and 14 couple together and are inhibited from separating from each other when in use installed into the fence.

In the context of the present invention the channel 74 and the slot 68 are collectively referred to as a “mating slot” of the outer member 14. The mating slot is essential to the capacity of the insulator/buffer 10 to be retrofitted to an existing fence installation. Without the mating slot the outer member 14 would have to be inserted from a free end of the fence wire 18 and this could only be done after the fence wire has passed through the hole 26 in the fence post 16 and would prevent retrofitting of the insulator/buffer 10 to an existing fence installation.

The keyway 72 is disposed along the length of the C-shaped portion 70. As can be better seen in FIG. 1, the keyway 72 is generally rectangular in cross-section for mating with the key 42 of the inner member 12.

Typically, the outer member 14 is about 20 mm long, the base 60 about 20 mm in diameter, the body 62 about 16 mm long, the mating slot about 5 mm wide and the keyway about 5 mm wide.

Typically, the inner member 12 and the outer member 14 are connected via an elongate flexible web (not shown) conveniently disposed between their respective bases 30 and 60. The web may be relatively short and able to be broken or ruptured by a user pulling and/or twisting the members 12 and 14 with respect to each other, or by cutting with scissors or the like. Alternatively, the web could be relatively long, such that the members 12 and 14 may be coupled together, as shown in FIG. 1, with the web still joining the two members 12 and 14 together. In either case, the purpose of the web is to keep the members 12 and 14 as a pair during transportation, so as to reduce the chances of unpairing of the members 12 and 14 to make it more convenient to retrieve a pair of the members 12 and 14 from a bag containing many pairs, such as, for example, tens or hundreds of pairs of the members 12 and 14.

Once assembled the members 12 and 14 form a bobbin, defining a shaft having a length of about 15 mm. The shaft length is typically somewhat longer then the width of the thickness of the flange 22 of the fence post 16. The shaft length is mainly chosen for manageability of the members 12 and 14. Where the shaft is significantly shorter than about 15 mm hand assembly into the hole 26 in the fence post 18 may become difficult. That is to say, the bases 30 and 60 of the respective members 12 and 14 do not have to rest flush with the sides of the flange 22.

The material from which the insulator/buffer 10 is made must be capable of withstanding the mechanical force of the motion of the fence wire 18 with respect to the fence post 16. Also, where the insulator/buffer 10 of the present invention is used in an electrified fence installation it is important that the members 12 and 14 be made of electrically insulative material, such as, for example, an electrically insulative plastic material, such as, for example, acrylonitrile butadiene styrene (commonly referred to as ABS plastic). The plastic typically needs to have an electrical insulative capacity in excess of about 20,000 volts.

However, the insulator/buffer 10 could be used in a wire fence installation that is not electrified, in which case the insulator/buffer 10 does not have to be electrically insulative. In such a case the device of the present invention acts as a buffer between the fence wires 18 and the fence posts 16 for inhibiting abrasion of the fence wires 18 against the fence posts 16. In this context the device of the present invention is referred to as a “fence wire buffer”.

The construction of the electric fence insulator 10 of the present invention and the fence wire buffer 10 of the present invention are substantially the same, the main difference being that the materials from which the latter device is constructed do not have to be electrically insulative.

### Embodiment 2

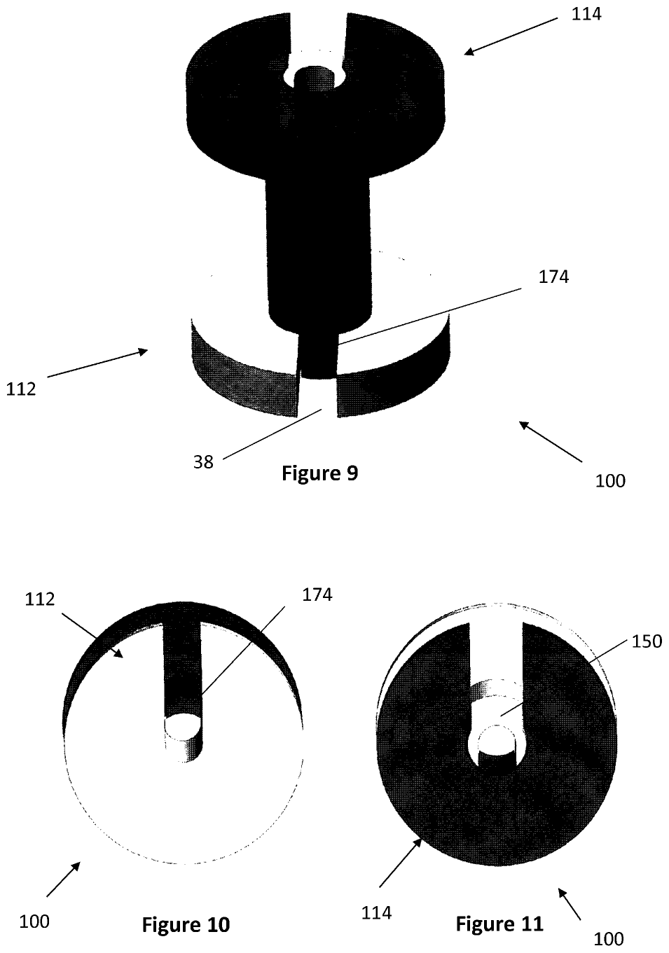

FIGS. 9 to 17 show an embodiment of the electric fence insulator 100 of the present invention, similar to Embodiment 1 shown in FIGS. 1 to 5. The electric fence insulator 100 is similar to the electric fence insulator 10 and like numerals denote like parts.

The difference between Embodiment 2 and Embodiment 1 is that the electric fence insulator 100 has different features on its inner member 112 and its outer member 114.

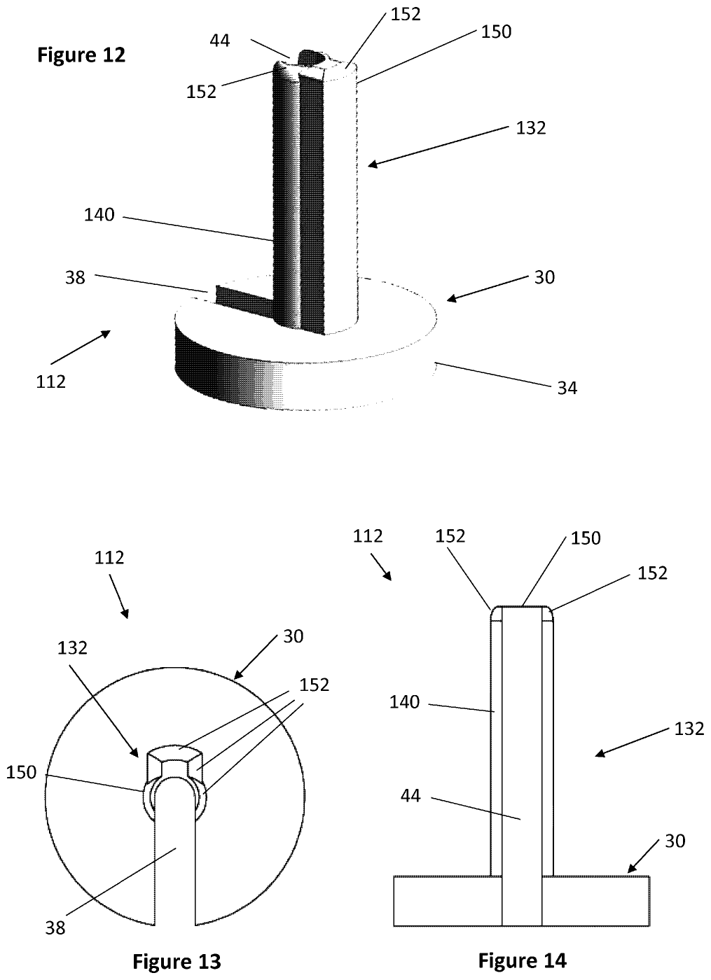

In particular, as shown in FIGS. 12 to 17, the inner member 112 has an elongate body 132 with a U-shaped portion 140 that is devoid of the ribs 48 of Embodiment 1. The elongate body 132 also has a free end 150 with chamfered corners 152 to assist in allowing insertion of the inner member 112 into the outer member 114.

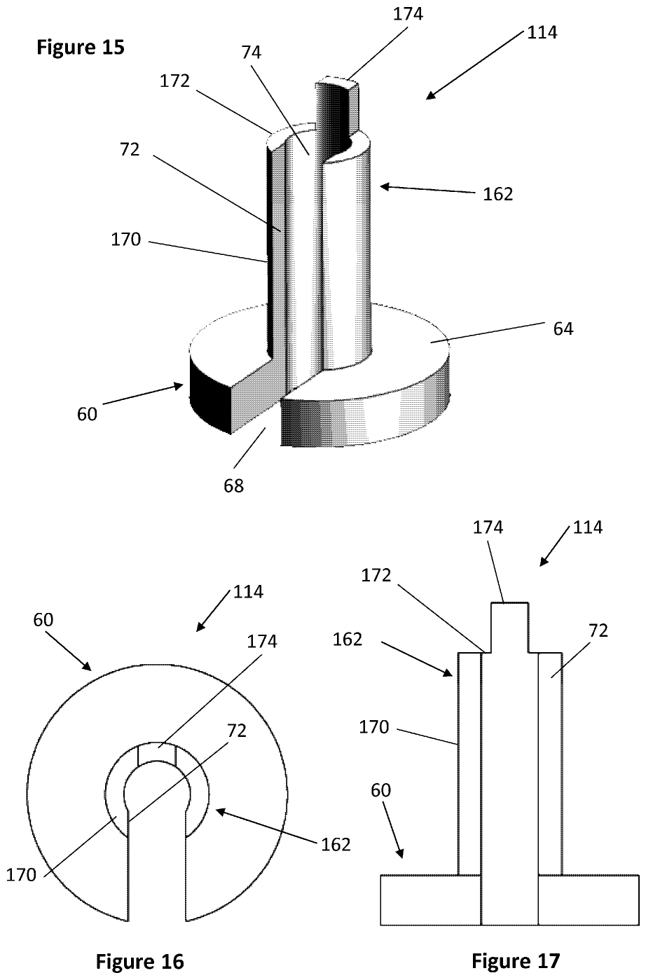

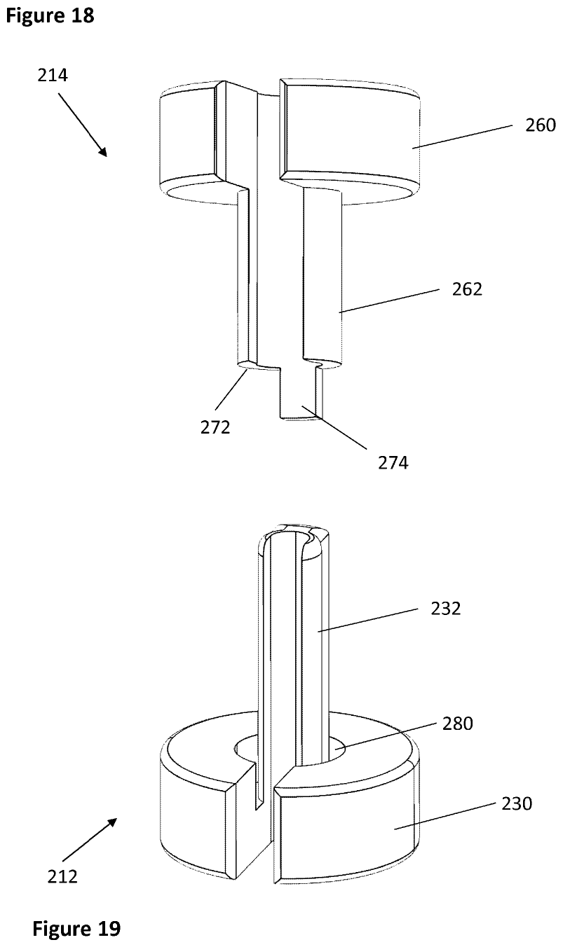

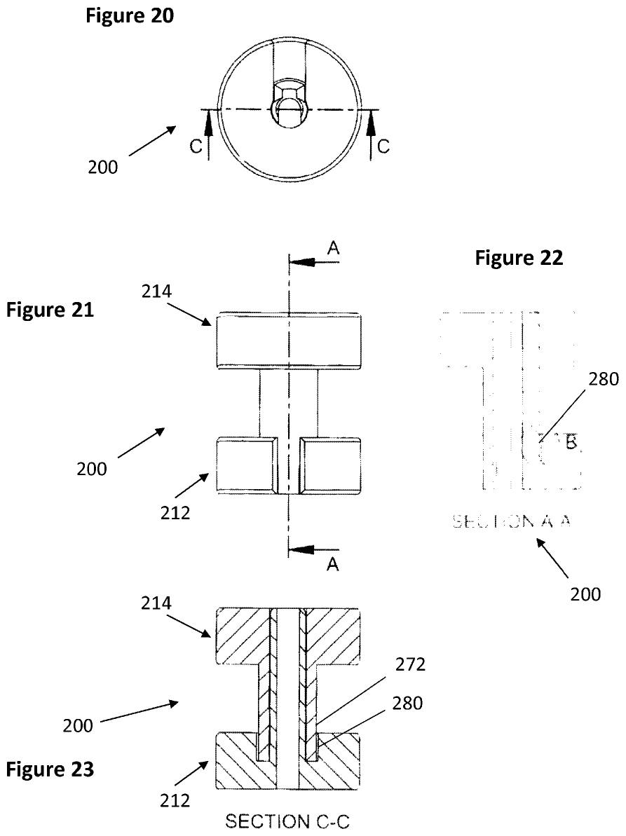

Also, as shown in FIGS. 15 to 17, the outer member 114 has an elongate body 162 with a C-shaped portion 170 that is devoid of the grooves 76 of Embodiment 1. The elongate body 162 has a free end 172 with a protrusion conveniently in the form or a finger or tab or tongue 174. The tongue 174 is dimensioned to fit into the slot 38 of the inner member 112 and to conform to the curvature of the fence wire 18 received in the channel 44 as shown in FIG. 9.

It has been found that the ribs 48 and grooves 76 may be omitted provided that the external dimensions of the U-shaped portion 140 of the elongate body 132 are substantially the same as the inner dimensions of the elongate body 162 as conveniently shown in FIGS. 9 to 11.

### Embodiment 3

The Figures show an electric fence insulator 200 of the present invention, similar to Embodiments 1 and 2, and like numerals denote like parts.

The difference between Embodiment 3 and Embodiments 1 and 2 is that the electric fence insulator 200 has an inner member 212 and an outer member 214 that have thicker bases 230 and 260, respectively, so as to provide greater electrical insulation to better inhibit leakage of electrical energy from the fence wire 18 to the fence post 16. The bases 230 and 260 form the “means for centralising” the inner member 212 and the outer member 214 with respect to the fence post 16 in the lateral aperture 26.

The inner member 212 also differs in that it has an annular groove 280 surrounding the junction between the elongate body 232. The annular groove 280 is dimensioned to receive the free end of the elongate body 262 of the outer member 214.

### Further Variations

It is envisaged that the bases 30, 230 and 60, 260 could be coloured so as to give a distinctive visual effect to a wire fence fitted with the insulator/buffers 10, 100, 200 of the present invention.

It is also envisaged that the bases 30, 230 and 60, 260 could be provided with glow means for achieving a glow in the dark effect. The glow means could be in the form of a phosphorescent additive to the plastics material used to make the insulator/buffers 10, 100, 200 of the present invention.

It is further envisaged that the cross-sectional shape of the ribs 48 and their corresponding grooves 76 could be made such that once the members 12 and 14 are pushed together it is more difficult to pull them apart. Such asymmetrical force of assembly and disassembly of the members 12 and 14 could be achieved with an asymmetric cross-sectional shape for the respective ribs 48 and grooves 76. For example, the cross-sectional shape of the ribs 48 and grooves 76 could be saw-toothed.

It is further envisaged that the insulator/buffer 10, 100, 200 of the present invention could be made from other plastics materials, such as, for example, UV stabilised nylon 6, or carbon impregnated nylon or the like.

It is further envisaged that the insulator/buffer 10, 100, 200 of the present invention could be provided with an LED (light emitting diode) capable of being driven by the charge in the fence wire 18, so that at night the LEDs along a wire fence fitted with the insulator I buffers 10, 100, 200 could glow at night time. Also, since electrified fences are usually pulsed, rather than continuously charged, the LEDs could have the effect of illuminating in rapid succession and then extinguishing, resulting in a distinctive visual effect.

It is further envisaged that a plurality of the insulator/buffers 10, 100, 200 of the present invention could be joined together in a gang for more convenient and faster application to the wire fence. The ganging of the inner member 12, 112, 212 and the outer member 14, 114, 214 is conveniently achieved by providing a short “rupturable” plastic connector between the bases 30, 230 and 60, 260 respectively. Rupturable, in this context, means that the connector can be broken by pulling the members 12, 112, 212 and 14, 114, 214 apart.

Alternatively, the plastic connector could be long enough so that it is not necessary to rupture the connector in order to permit assembly of the inner member 12, 112, 212 and the outer member 14, 114, 214. In such situation the connector does not need to be rupturable.

It is further envisaged that the centraliser means could be joined together with the inner and outer members 212 and 214 in a gang for more convenient and faster application of the fence wire insulator 200 to the fence wire 18. The ganging of the members 212 and 214 and the centraliser means is conveniently achieved by providing an elongate plastic connector between the bases 30 and 60 and the centraliser means. The plastic connector may be “rupturable”, which, in this context, means that the connector can be broken by pulling the members 212 and 214 apart. However, the plastic connector may be made long enough that the members 212 and 214 can be assembled without rupturing the plastic connector.

In an alternative embodiment the means for centralising the members 212 and 214 is a centraliser capable of reaching around the main flange 22 of the fence post 16 and fitting between the bases 230 and 260 and the main flange 22.

It is envisaged that the centraliser could be in the form of a clip means capable of fastening by clipping about the elongate body 262 of the outer member 214.

It is further envisaged that the external dimensions of the bases 230 and 260 could be greater than the bases 30 and 60 so as to increase the path that electrical energy must take from the fence wire 18 to the fence post 16.

### USE

### Embodiment 1

In use, wire fence insulator/buffers 10 of the present invention are applied to an existing wire fence installation. The fence installation may be or may be intended to be electrified or not. If intended to be electrified, it is important that the fence not be electrically charged at the time the insulator/buffers 10 are applied to the wire fence.

Installation of the insulator/buffers 10 of the present invention to a wire fence is achieved by first locating the inner member 12 onto a respective fence wire 18; then sliding the inner member 12 into one of the respective holes 26 of the fence post 16; then locating the outer member 14 onto the said fence wire 18 on the opposite side of the said fence post 16; aligning the inner member 12 with the out member 14; and sliding the outer member 14 into the said hole 26 from the opposite side of the said fence post 16. It may be necessary to pivot the inner member 12 with respect to the outer member 14 in order to align with the key 42 with the keyway 72. Once aligned the outer member 14 can be inserted further into the hole 26 and over the inner member 12 within and through the said hole 26. The outer member 14 is further inserted upon the inner member 12 until the free end of the bodies 32 and 62 bear against respective inner faces 34 and 64 of the respective members 12 and 14. By this insertion the ribs 48 ride into the grooves 76 thus coupling the inner member 12 and the outer member 14 together to inhibit discharge of electrical energy from the fence wire to the fence post and/or to inhibit wear and corrosion of the fence wire 18 with the fence pot 16.

The process of assembly of the inner member 12 and the outer member 14 into the lateral aperture 26 is shown in FIGS. 6 to 8, respectively. In FIG. 6, the members 12 and 14 are aligned with the fence wire 18. In step 2 the members 12 and 14 are located upon the fence wire 18. In step 3 the members 12 and 14 are urged towards each other into the lateral aperture 26 wherein the inner and outer members 12 and 14 couple together and clip together to insulate the fence wire 18 with respect to the fence post 16.

Once assembled together the members 12 and 14 are prevented from pivoting with respect to each other. This is important since otherwise pivoting could result in the slots 38 and 68 and the U-shaped portion 40 and the C-shaped portion aligning, which would expose the fence wire 18 to the fence post 16 and lead to leakage of electricity from the fence wire 18 to the fence post 16 and hence to the ground, which could have the effect of rendering the electrification of the wire fence inoperative. Also, if pivoting of the members 12 and 14 with respect to each other is permitted it could lead to the members falling apart and the fence wire 18 coming into direct contact with the fence post 16 which could damage an energiser used to electrify the wire fence.

Testing of the wire fence insulator/buffers 10 of the present invention was carried out to assess the electrical insulative efficiency of the design. The test included installation of one insulator buffer 10 on a fence post 16, and connected to a charge device in the kind of configuration commonly used for electrified fences. The charge devices was energised to deliver 5.9 kV to the fence wire 18. A stream of water, from a garden hose, was applied directly onto the insulator/buffer 10. The stream of water reduced the voltage at the fence wire to 5.7 kV. The same test was carried out with conventional electric fence insulators and the same voltage drop was experienced. Hence, this test demonstrates that the insulator/buffer 10 of the present invention does provide electrical insulation of the fence wire 18 with respect to the fence post 16.

### Embodiment 2

In use, wire fence insulator/buffer 100 of the present embodiment is used in substantially the same manner as the wire fence insulator/buffer 10. The main difference is that the tongue 174 is inserted into the slot 38 of the base 34 to reduce the likelihood of leakage of electricity from the electrified fence wire 18 to the fence post 16.

### Embodiment 3

In use, wire fence insulator/buffer 200 of the present embodiment is used in substantially the same manner as the wire fence insulator/buffer 10. The main difference is that where a centraliser means is used it is clipped to the outer member 214 about its elongate body 262 to centralise the wire fence insulator/buffer 200 about the main flange 22. Also, use differs in that the free end 272 of the elongate body 262 fits into the annular groove 280 to increase the electrical insulation and reduce the leakage of electrical energy—particularly with relatively high voltage charge devices (typically above 10 kV).

### INDUSTRIAL APPLICABILITY

The wire fence insulator and buffer 10, 100, 200 of the present invention is suitable for application to wire fences of the type where fence wire passes through holes in fence posts 16.

The wire fence insulator and buffer 10, 100, 200 of the present invention resides and operates in the field of wire fencing. More particularly the present invention resides and operates in the field of insulators for electrified wire fences and in the field of buffers for non-electrified wire fences. The wire fence insulator and buffer 10, 100, 200 of the present invention does not relate to the art of fence wires that are attached to the sides of fence posts, wherein the fence wires are tied with wire or other fixings to the side of the fence posts.

The consequence of the use of the wire fence insulator and buffer 10, 100, 200 of the present invention is that it can be retrofitted to existing wire fence installations without the need to add strands of wire 18 to the fence. Also, the insulator and buffer 10, 100, 200 has the effect of electrically insulating fence wire 18 with respect to the fence posts 16 in electrified fences, and the effect of reducing wear between the fence wire 18 and the fence post 16 in both electrified and non-electrified fences.

### REFERENCE SIGNS

The specification uses the following reference signs:

| | |
|---|---|
| 10 | electric fence insulator |
| 12 | inner member |
| 14 | outer member |
| 16 | fence post |
| 18 | fence wire |
| 22 | main flange |
| 24 | minor flange |
| 26 | hole |
| 30 | base |
| 32 | elongate body |
| 34 | inner face |
| 36 | outer face |
| 38 | slot |
| 40 | U-shaped portion |
| 42 | key |
| 44 | channel |
| 46 | back |
| 48 | ribs |
| 60 | base |
| 62 | elongate body |
| 64 | inner face |
| 66 | outer face |
| 68 | slot |
| 70 | C-shaped portion |
| 72 | keyway |
| 74 | channel |
| 76 | grooves |
| 100 | electric fence insulator |
| 112 | inner member |
| 114 | outer member |
| 132 | elongate body |
| 140 | U-shaped portion - inner member |
| 150 | free end |
| 152 | chamfered corners |
| 162 | elongate body |
| 170 | C-shaped portion |
| 172 | free end |
| 174 | tab |
| 200 | electric fence insulator |
| 212 | inner member |
| 214 | outer member |
| 230 | base - inner member |
| 260 | base - outer member |
| 232 | elongate body - inner member |
| 262 | elongate body - outer member |
| 272 | free end |
| 274 | tongue |
| 280 | annular groove |

### ADVANTAGES

The wire fence insulator and buffer 10, 100, 200 of the present invention has the advantage that it can be retrofitted to an existing wire fence. This means that an existing non-electrified wire fence can be turned into an electrified fence without the need to add more strands of wire to the fence, thus saving time and cost in the conversion process.

The wire fence insulator and buffer 10, 100, 200 of the present invention also has the advantage that it provides a mechanical buffer between the fence wire 18 and the fence post 16 which has the effect of reducing wear between the fence wire 18 and the fence post 16 and increasing the serviceable life or the wire fence installation.

The wire fence insulator and buffer 10, 100, 200 of the present invention can be retro-fitted to an existing fence or to a new fence during its construction.

### MODIFICATIONS AND VARIATIONS

It will be readily apparent to persons skilled in the relevant arts that various modifications and improvements may be made to the foregoing embodiments, in addition to those already described, without departing from the basic inventive concepts of the present invention. For example, the bodies 32 and 62 could have a cross-section that is other than round, thus reducing the reliance upon the key 42 and the keyway 72 to prevent pivoting of the inner member 12 with respect to the outer member 14. Also, the bodies 132 and 162 could have mating cross-sections that is other than round, thus reducing the reliance upon the key 42 and the keyway 72 to prevent pivoting of the inner member 12 with respect to the outer member 14. At the same time the bodies 132 and 162 still require round sections to correspond with the cross section of the fence wire 18.

1. An electric fence insulator for a fence post having spaced apart lateral apertures with fence wire passing through them, the electric fence insulator comprising:
an inner member and an outer member capable of coupling together around the fence wire within respective ones of the lateral apertures of the fence post to inhibit leakage of electrical energy from the fence wire to the fence post;
wherein the inner member and the outer member can be coupled together in respective ones of the said lateral apertures around the fence wire after the fence wire has been fitted to the fence post.

2. The electric fence insulator of claim 1, in which the inner member also comprise an elongate body having a wire slot shaped to receive the fence wire extending along its length, the wire slot allowing the inner member to be located upon the fence wire so the body can pass through the said lateral aperture from one side of the fence post; and
the outer member also comprises an elongate body having a mating slot shaped to receive the body of the inner member, the mating slot extending along the length of the elongate body, the elongate body of the outer member being dimensioned to pass through the said lateral aperture from the other side of the fence post;
whereby the inner and outer members couple together within the lateral.

3. The electric fence insulator of claim 1, in which the inner and the outer members include means to resist their separation, once they are coupled together within the lateral aperture.

4. The electric fence insulator of claim 3, in which the means to resist separation is constituted by at least one lateral rib located on the elongate body of the inner member and a lateral groove located on the elongate body of the outer member, the lateral rib and the lateral groove being disposable to mate whilst the inner member and the outer member are located within the lateral aperture of the fence post, whereby the mating of the lateral rib and the lateral groove inhibits separation of the inner member and the outer member.

5. The electric fence insulator of claim 3, also comprising means for centralising the inner member and the outer member with respect to the fence post in the said lateral aperture.

6. The electric fence insulator of claim 5, in which the means for centralising the inner member and the outer member is constituted by two bases, one base being located at one end of the elongate body of the inner member and the other base being located at one end of the elongate body of the outer member, the two bases being disposed close to the fence post on opposite sides of the lateral aperture when the inner member and the outer member are coupled together in the lateral aperture, whereby the two bases substantially inhibit longitudinal movement of the insulator within the lateral aperture.

7. The electric fence insulator of claim 6, in which the base of the inner member has an annular groove surrounding the junction with its elongate body, the annular groove being dimensioned to receive the free end of the elongate body of the outer member.

8. The electric fence insulator of claim 7, in which the wire slot of the inner member extends along its elongate body, through its base and through its annular groove, and in which the outer member has a tongue projecting from the free end of its elongate body, the tongue being dimensioned to substantially fill the portion of the wire slot in the base of the inner member.

9. The electric fence insulator of claim 5, further comprising a flexible elongate web connecting the inner member and the outer member together to for a pair of members for use together in the same lateral aperture in the fence post.

10. A fence wire buffer for a fence post having lateral spaced apart apertures with fence wire passing through them, the fence wire buffer comprising:
an inner member and an outer member capable of coupling together around the fence wire within respective ones of the lateral apertures of the fence post to inhibit contact of the electric wire with the fence post;
wherein the inner member and the outer member can be coupled together in respective ones of the said lateral apertures around the fence wire after the fence wire has been fitted to the fence post.

11. The fence wire buffer of claim 10, in which the inner member also comprise an elongate body having a wire slot shaped to receive the fence wire extending along its length, the wire slot allowing the inner member to be located upon the fence wire so the body can pass through the said lateral aperture from one side of the fence post; and
the outer member also comprises an elongate body having a mating slot shaped to receive the body of the inner member, the mating slot extending along the length of the elongate body, the elongate body of the outer member being dimensioned to pass through the said lateral aperture from the other side of the fence post.

12. The fence wire buffer of claim 10, in which the inner and the outer members include means to resist their separation, once they are coupled together within the lateral aperture.

13. The fence wire buffer of claim 12, in which the means to resist separation is constituted by at least one lateral rib located on the elongate body of the inner member and a lateral groove located on the elongate body of the outer member, the lateral rib and the lateral groove being disposable to mate whilst the inner member and the outer member are located within the lateral aperture of the fence post, whereby the mating of the lateral rib and the lateral groove inhibits separation of the inner member and the outer member.

14. The fence wire buffer of claims 12, further comprising means for centralising the inner member and the outer member with respect to the fence post in the said lateral aperture.

15. The fence wire buffer of claim 14, in which the means for centralising the inner member and the outer member is constituted by two bases, one base being located at one end of the elongate body of the inner member and the other base being located at one end of the elongate body of the outer member, the two bases being disposed close to the fence post on opposite sides of the lateral aperture when the inner member and the outer member are coupled together in the lateral aperture, whereby the two bases substantially inhibit longitudinal movement of the fence wire buffer within the lateral aperture.

16. The fence wire buffer of claim 15, in which the base of the inner member has an annular groove surrounding the junction with its elongate body, the annular groove being dimensioned to receive the free end of the elongate body of the outer member.

17. The fence wire buffer of claim 16, in which the wire slot of the inner member extends along its elongate body, through its base and through its annular groove, and in which the outer member has a tongue projecting from the free end of its elongate body, the tongue being dimensioned to substantially fill the portion of the wire slot in the base of the inner member.

18. An electric fence system comprising:
a plurality of fence posts arranged in side-by-side spaced apart relation, each fence post having at least one lateral aperture extending through it;
at least one fence wire capable of carrying electric current, the at least one fence wire being disposed through a corresponding one of the lateral apertures in the fence posts; and
a plurality of electric fence insulators for electrically insulating the fence wires from the fence posts, each electric fence insulator comprising:
an inner member and an outer member capable of coupling together around the fence wire within respective ones of the lateral apertures of the fence post to inhibit leakage of electrical energy from the fence wire to the fence post;
wherein the inner member and the outer member can be coupled together in respective ones of the said lateral apertures around the fence wire after the fence wire has been fitted to the fence post; and
an electric charge device for delivering electric charge to the fence wire.

19. The electric fence system of claim 18, wherein the electric fence insulator is as further defined in claim 5.

20. A method of electrifying a wire fence having a plurality of fence posts each with lateral spaced apart apertures with respective fence wires passing through them, by using a fence post insulator comprising an inner member with an elongate body having a wire slot shaped to receive the fence wire extending along its length, the wire slot allowing the inner member to be located upon the fence wire so the body can pass through the said lateral aperture from one side of the fence post, and an outer member with an elongate body having a mating slot shaped to receive the body of the inner member extending along its length, the body of the outer member being dimensioned to pass through the said lateral aperture from the other side of the fence post, the method comprising the steps of:
locating the wire slot of the inner member onto a respective one of the fence wires;
sliding the inner member about the respective fence wire into one of the lateral apertures of the fence post;
locating the mating slot of the outer member onto the said fence wire on the opposite side of the said fence post from the inner member;
aligning the inner member and the outer member;
inserting the inner member into the outer member within the said lateral aperture for coupling the inner member and the outer member together; and
sliding the outer member into the said lateral aperture;
whereby the electric fence insulator inhibits discharge of electrical energy from the fence wire to the fence post.
